(19) United States
(12) Patent Application Publication
(10) Pub. No.: US 2012/0021226 A1
(43) Pub. Date: Jan. 26, 2012

(54) FLUOROPOLYMER MULTI-LAYER ARTICLES

(76) Inventors: Mark W. Muggli, Emmerting (DE); Shaun P. Duhaime, Maplewood, MN (US); Craig R. Hoff, Corcoran, MN (US); Mark J. Williams, Cottage Grove, MN (US); Gregg D. Dahlke, St. Paul, MN (US)

(21) Appl. No.: 12/809,093

(22) PCT Filed: Dec. 15, 2008
(86) PCT No.: PCT/US08/86782

§ 371 Date: Jun. 18, 2010

Related U.S. Application Data
(60) Provisional application No. 61/016,060, filed on Dec. 21, 2007.

(51) Int. Cl. B32B 27/08

(52) U.S. Cl. 428/421

(57) ABSTRACT

Provided is a multilayer article having a partially fluorinated or a perfluorinated fluoroplastic layer, a layer that comprises a copolymer comprising interpolymerized units derived from at least one monomer having a glycidyl functional group, and a substrate. The second layer is disposed between the first layer and the substrate layer and adhesively bonds the first layer and substrate layer. Optionally, there is provided a third layer including a perfluoroplastic, where the first layer is disposed between the second layer and the third layer and adhesively bonds the second layer to the third layer. Also provided are methods of making multilayer articles and methods of using multilayer articles.

### FIELD OF THE INVENTION

The present disclosure relates to multilayer articles including fluoropolymer compositions. The present disclosure specifically relates to multilayer articles including fluoropolymer compositions having glycidyl functional groups.

### BACKGROUND OF THE INVENTION

Bonding fluoropolymers to other materials can be difficult. Such bonding typically requires combinations of strong bases, amines or reducing agents. Bonding fluoropolymers to other materials also typically requires additional compounding steps or the use of bonding agents (or other chemicals) that negatively impact the physical properties of base resins. The present disclosure provides a fluoropolymer composition that exhibits good bonding to other materials, which can be useful in the creating multi-layer articles, such as high density polyethylene (HDPE) tubing, multi-layered films and other articles that require fabrication with good bonding between layers.

### SUMMARY

The present description relates to multilayer articles having a first layer including a partially fluorinated fluoroplastic having a melting point measured by differential scanning calorimetry (DSC) of at least 200° C. or more, 210° C. or more, or even 220° C. or more and a second layer having a copolymer comprising interpolymerized units derived from at least one monomer having a glycidyl functional group, where the second layer is substantially free of curatives. Further, the multilayer articles include a substrate layer where the second layer is disposed between the first layer and the substrate layer and adhesively bonds the first layer and substrate layer.

In another aspect, the present description relates to multilayer articles including a first layer having a partially fluorinated fluoroplastic and a second layer having a copolymer comprising interpolymerized units derived from at least one monomer having a glycidyl functional group, where the functional monomer is present at less than 2 weight percent of the polymer, and where the second layer is substantially free of curatives. Further, the multilayer articles include a substrate layer where the second layer is disposed between the first layer and the substrate layer and adhesively bonds the first layer and substrate layer.

In still another aspect, the present description relates to multilayer articles including a first layer having a perfluoroplastic. The multilayer articles further comprise a second intermediate bonding layer having a copolymer including interpolymerized units derived from at least one monomer having a glycidyl functional group. Further, the multilayer articles include a substrate layer where the second layer is disposed between the first layer and the substrate and adhesively bonds the first layer and the substrate layer.

In yet another aspect, the present description also provides an optional third layer having a perfluoroplastic where the first layer is disposed between the second layer and the third layer and adhesively bonds the second layer to the third layer.

It is an advantage of the present disclosure, in some embodiments, to provide compositions for bonding fluoropolymers to other materials. Other features and advantages of the present disclosure may be apparent from the following detailed description and the claims.

### DETAILED DESCRIPTION

Fluoroplastics according to the present description may be partially fluorinated or perfluorinated. Such fluoroplastics may be derived, at least in part, from monomers containing one or more fluorine atoms. Particular monomers include, for example, tetrafluoroethylene, hexafluoropropylene, vinylidene fluoride, vinyl fluoride, perfluoro(alkyl vinyl)ethers, perfluoro(alkoxy vinyl)ethers, and chlorotrifluoroethylene. The fluoroplastics may further be derived from the interpolymerization of fluorine-containing monomers with non fluorine-containing monomers such as, for example, alpha-olefins (e.g., ethylene, propylene).

In some embodiments, the fluoroplastics described herein may have a melting point, as measured by differential scanning calorimetry (DSC) of 200° C. or more, 210° C. or more, or even 220° C. or more.

In further embodiments, the fluoroplastics described herein may be copolymers of ethylene and tetrafluoroethylene (ETFE); copolymers of tetrafluoroethylene, hexafluoropropylene, and ethylene (HTE); copolymers of tetrafluoroethylene and hexafluoropropylene (FEP); copolymers of tetrafluoroethlyene and a perfluoro(alkyl vinyl)ether (PFA); or copolymers of tetrafluoroethylene, hexafluoropropylene, vinylidene fluoride, and optionally a perfluoro(alkyl vinyl)ether (THV). The term “copolymer” as used herein means any number of various interpolymerized monomer units, including, for example, two, three, four or more monomers.

When the fluoroplastic is a THV fluoroplastic, the amount of tetrafluoroethylene may vary, for example, the amount of THV fluoroplastic may be in a range from 30 mol % to 100 mol %, 40 mol % to 100 mol %, 50 mol % to 100 mol %, 60 mol % to 100 mol %, even 70 mol % to 100 mol %. Other exemplary amounts of tetrafluoroethylene may be in a range of 85 mol % to 0 mol %, 80 mol % to 0 mol %, 70 mol % to 0 mol %, 60 mol % 0 mol %, 50 mol % to 0 mol %, or even 40 mol % to 0 mol %. The amount of hexafluoropropylene may also vary, for example, the amount of hexafluoropropylene may be in a range from 3 mol % to 100 mol %, from 5 mol % to 100 mol %, from 10 mol % to 100 mol %, or even from 12 mol % to 100 mol %. In another example, the amount of hexafluoropropylene may be in a range from 20 mol % to 0 mol %, 15 mol % to 0 mol %, 10 mol % to 0 mol %, or even 7 mol % to 0 mol %. The amount of vinylidene fluoride may vary. Exemplary amounts of vinylidene fluoride may be in a range from 10 mol % to 100 mol %, from 15 mol % to 100 mol %, from 20 mol % to 100 mol %, from 30 mol % to 100 mol %, even from 35 mol % to 100 mol %. Other exemplary amounts of vinylidene fluoride may be in a range from 60 mol % to 0 mol %, 50 mol % to 0 mol %, 35 mol % to 0 mol %, or even 20 mol % to 0 mol % The amount of perfluoro(alkyl vinyl)ether may be in a range from 0 mol % to approximately 5 mol %. For example, the amount may be in a range from 0 mol % to 3 mol %, 0 mol % to 2 mol %, or even 0 mol % to 1.5 mol %.

Typical perfluorothermoplastics are semi-crystalline copolymers made up primarily of units of tetrafluoroethylene (TFE) and of perfluoro-(alkyl vinyl)ethers such as perfluoro-(n-propyl vinyl)ether (PPVE) or perfluorinated olefins such as hexafluoropropylene (HFP). Copolymers made of TFE and PPVE are commercially available under the trade designation “PFA,” (Dyneon LLC, Oakdale, Minn.) and copolymers of TFE with HFP are available under the trade designation “FEP” (Dyneon LLC, Oakdale, Minn.). PFA is extensively described in Modern Fluoropolymers, John Wiley & Sons, 1997, p. 223 ff., and FEP in Kirk-Othmer, Encyclopedia of Chemical Technology, John Wiley & Sons, Fourth Edition, Volume 11 (1994), p. 644. Copolymers such as PFA and FEP can also contain additional perfluorinated comonomers. In this regard, the term “perfluorinated thermoplastics” as used herein mean that the resin contains no hydrogen except in the end groups.

Both PFA and FEP have thermally unstable end groups, whether or not radical polymerization was carried out in an aqueous or non-aqueous system. These thermally unstable end groups, including —COOH, —COF, and —CONH₂, can be detected by infrared (IR) analysis. The unstable end groups can have a negative effect on the processing of such materials, such as the formation of bubbles and discoloration in the end article.

The removal of unstable end groups by means of fluorination is known in the art. A particularly useful means of this removal is described in U.S. Pat. No. 6,693,164 to Blong et al. The removal of the end groups is accomplished in the agglomerate and pellet form of the fluoropolymer. The fluoropolymer is preferably dry during fluorination. In some embodiments, this step occurs in an essentially stationary bed. The term “essentially stationary bed” as used herein means that both the container for holding the agglomerate and/or pellet and the agglomerate and/or pellet itself are not subject to significant movement during the fluorination process. The agglomerate and/or pellet is loaded into the container, the fluorine-containing media is added to the container and a period of contact occurs. The fluorine-containing media, such as a fluorine-containing gas, may be replenished to allow multiple cycles of contact using fresh fluorine-containing media. This is in contrast to prior methods of fluorination in which the container is designed to agitate or tumble the polymer by, for example, rotating the container.

In the present disclosure, however, unstable end groups are desirable in the first layer to achieve improved adhesion based on T-peel testing. In accordance with the first layer of the present disclosure, what is sought are perfluoroplastics that have a sum of unstable end groups, which can be detected with IR, greater than 30 per 10⁶ carbon atoms, in some embodiments greater than 60 per 10⁶ carbon atoms, and even greater than 90 per 10⁶ carbon atoms. Without wishing to be bound by theory, it is believed that a higher number of unstable end groups results in improvements in adhesion.

The first layer may comprise a fluoroplastic as described herein. The first layer may further comprise any known additive, such as, for example, a pigment, carbon black, processing aids, and the like. The first layer may include a single fluoroplastic or blends of fluoroplastics. In embodiments in which the first layer comprises partially fluorinated thermoplastics, it is understood that blends of partially fluorinated thermoplastics and perfluoroplastics, as described, for example, in U.S. Pat. Publ. Nos. 2005/0124717 to Jing, Naiyong et al. and 2003/0198769 to Jing, Naiyong et al. are disclosed.

The second layer described herein comprises a copolymer comprising interpolymerized units derived from at least one monomer having a glycidyl functional group. This second layer may, in some embodiments, be substantially free of curatives. By substantially free of curatives is meant an amount that is insufficient to cure a polymer having a glycidyl functional group during processing.

Glycidyl functional groups can be crosslinked in many ways. They can be thermally homopolymerized, particularly with the aid of Lewis or Bronsted acid catalysts. In addition to instant catalysts, there are also many examples of latent acid catalysts, which can be generated thermally or photochemically. Imidazoles and tertiary amines also catalyze the homopolymerization of epoxy resins; this is accomplished by a nucleophilic mechanism.

Glycidyl functional groups can also be cured with stoichiometric curatives. Examples include aliphatic and aromatic amines, mercaptans, phenolic resins, carboxylic acids and their derivatives (particularly anhydrides), and related materials, such as guanidines and hydrazines. Aminosilanes are an example of this type of curative.

In particular embodiments, the second layer is substantially free of curatives and the first layer comprises a partially fluorinated fluoroplastic. In further embodiments, the first layer comprises a perfluorinated fluoroplastic and the second layer may or may not be substantially free of curatives.

The copolymers comprising interpolymerized units derived from at least one monomer having a glycidyl functional group described herein are not particularly limited. Embodiments of such materials include those copolymers derived from interpolymerized units of glycidyl methacrylate (GMA). Examples of such embodiments include, for example, copolymers of glycidyl methacrylate with an alpha-olefin (such as ethylene, propylene), an alkyl acrylate (such as methyl acrylate, ethyl acrylate), an alkyl methacrylate (such as methyl methacrylate, ethyl methacrylate), and combinations thereof. Further embodiments include polymers having a glycidyl functional group (e.g., glycidyl-containing monomer such as glycidyl methacrylate) incorporated into the polymer backbone, or grafted onto a sidechain.

The present disclosure also provides for an optional third layer comprising a perfluoroplastic. This perfluoroplastic may have a number of unstable end groups less than 30 per 10⁶ carbon atoms, in some embodiments less than 5 per 10⁶ carbon atoms and in some embodiments less than 1 per 10⁶ carbon atoms. This optional layer is only in contact with the first layer herein disclosed, such that the first layer is between the third layer and the second layer.

When this optional third layer is present, and the first layer is a partially fluorinated thermoplastic, there is a bonding interface between said first layer and said third layer. This bonding layer includes a first material having the composition of the first layer and a second material having the composition of the third layer, as is described in the U.S. Pat. Publ. No. 2003/0198770 to Fukushi, Tatsuo et al. It is further understood that blends of partially fluorinated thermoplastics and perfluoroplastics, as described, for example, in U.S. Pat. Publ. Nos. 2005/0124717 to Jing, Naiyong et al. and US2003/0198769 to Jing, Naiyong et al., may include the first layer, with the third layer comprising a perfluoroplastic. When this optional third layer is present, and the first layer is also a perfluoroplastic, it is understood that the perfluoroplastic of layer third can be the same as or different than the perfluoroplastic of the first layer.

In this manner, the present description provides a mechanism for bonding to fluoropolymers, polystyrene, polymethylmethacrylate and polysulfone based polymer materials having GMA comonomers. Furthermore, due to their adhesion to metals and glass, glycidyl functional polymers with proper thermal stability may be used in bonding fluoropolymer powders to metal or glass substrates for use in, for example, bakeware, cookware, chemical processing equipment, and the like. Articles that can be made according to the present description include films, tubes, blow-molded articles, and additive powders.

The multilayer articles described herein can be shaped into any number of configurations, depending, for example, upon the end-use to which they may be put. For example, multilayer articles may include a sheet, a hose, or any other molded, blown, or extruded shape. The multilayer articles can have layers having any thickness, and any overall thickness. For example, the overall thickness may be between 70 micrometers and 5000 micrometers.

The thickness of each layer of the multilayer articles described herein is not particularly limited. In some embodiments, the first layer may be from about 10 to 1000 micrometers thick, for example, and in some embodiments from 10 to 500 micrometers thick. In some embodiments, the second layer may be from about 10 to 1000 micrometers thick, for example, and in some embodiments from 10 to 200 micrometers thick. The substrate layer may be thicker than the first and/or second layer, for example, from 50 to 2000 micrometers thick, for example, from 100 to 1500 micrometers thick, from 250 to 1000 micrometers thick, and in some embodiments, from 500 to 1000 micrometers thick.

When the multilayer article is in the form of a hose, the first layer may be an outside layer, or may be an inside layer. When the multilayer article, in the form of a hose, includes an optional third layer, this third layer may be an outside layer or an inside layer. In some embodiments, it may be advantageous for the first layer to be an inside layer, such as, for example, when the hose is used in a fuel management system.

Because of increasingly stringent evaporative standards, fuel management system components (e.g., hoses, reservoirs, and the like) may contain multilayer articles having a fluoropolymer-containing layer. Such layers may provide resistance to permeation and/or evaporative fuel loss. In such an embodiment, the first layer may be disposed within a component of a fuel management system such that it is, in use, in contact with the fuel.

In some embodiments described herein, the presently described process of bonding fluoropolymers to other materials is simplified versus comparative techniques that require additional compounding steps or the use of chemicals that may negatively impact the physical properties of the substrate layer. For example, some techniques include chemical modification (i.e. processing, etching, etc.) of the fluoropolymers to enhance bondability of the fluoropolymers. These techniques can, however, create issues concerning purity of finished articles derived from these fluoropolymers, which can cause issues with approval from various regulatory agencies depending on the desired end use of the articles. Impurity issues can also be problematic in industries where high purity is desired, such as high purity water, semi-conductor applications, and the like.

In yet further embodiments, added adhesion promoters or bonding agents are optionally present at the interface between the first layer and the second layer described herein. Thus, in some embodiments, the interface between the first and second layer is substantially free of adhesion promoters or bonding agents. The ability to bond the first and second layer without the use of adhesion promoters or bonding agents may further allow for improvement in the color of the multilayer articles or the rheological properties of the materials in the first and/or second layers.

The multilayer articles described herein may be prepared by any conventional means, including, for example, extrusion, co-extrusion, lamination, and the like. In some embodiments, the first layer may be extruded at a temperature above the melting point of the fluoroplastic, for example, at a temperature between 0 and 120° C. higher than the melting point of the fluoroplastic. The first layer may be co-extruded with the second layer, or may be extruded onto the second layer. The second layer may be extruded onto the substrate, co-extruded with the substrate, laminated onto the substrate, or formed into a multilayer article by any other conventionally recognized means. Furthermore, the first layer, second layer, and substrate may all three be co-extruded, the first layer and second layer may be co-extruded onto the substrate, and the like.

Advantages and embodiments of this invention are further illustrated by the following examples, but the particular materials and amounts thereof recited in these examples, as well as other conditions and details, should be not be construed to unduly limit this invention. All parts and percentages are by weight unless indicated otherwise.

### EXAMPLES

General Multilayer Construction Parameters: The general construction of the multilayer articles described herein constituted a first (fluoropolymer) layer that was nominally 250 micrometers thick, a second layer that was nominally 150 micrometers thick, and optionally a third layer that, when present, was nominally 600 micrometers thick. When formed into tubes, the tubes had an inner diameter of nominally 6 mm. High density polyethylene (HDPE) was extruded at 210° C. and GMA-modified materials were extruded at 220° C.

Tube Initial Bonding Measurements: Initial bonding was measured by initiating a crack between the two layers on a part of a tube that had been split in half. Once a sufficient length of material was delaminated, one layer was inserted into the top jaw of a tensile tester (obtained from Instron as Model 5564, Norwood, Mass.). The remainder of the tube was inserted into the bottom jaw. The crosshead speed of the tensile tester was set at 150 mm/min. The width of the delamination that was peeled was nominally 12 mm.

Plaque Initial Bonding Measurements: A strip of the specimen to be tested, at least 12 mm wide and at least 2.5 cm in length, is prepared. A crack (1.0 cm minimum length) is initiated between the layers between which peel strength is to be measured. Each layer is placed in an opposed clamp of an Instron Tensile Tester (model 5564) obtained from Instron Corporation, Canton, Mass. Peel strength is measured at a cross-head speed of 150 millimeters/minute as the average load for separation of to the two layers. Reported peel strengths generally represent an average of at least three samples.

Unstable End Group Analysis: The unstable end groups, including —COOH, —COF, and —CONH₂, were determined by means of FTIR spectroscopy (FTIR Nicolet Magna 560 Spectrometer) at a film thickness of 100 micrometers, as indicated in U.S. Pat. No. 3,085,083 to Schreyer. The measured unstable end groups are the sum of the free and associated carboxyl groups, —CONH₂, and —COF per 10⁶ carbon atoms.

The abbreviations are used in the Examples that follow:

TABLE OF ABBREVIATIONS

| ABBREVIATION | DESCRIPTION |
|---|---|
| THV 220G | Copolymer of tetrafluoroethylene (TFE), |
| | hexafluoropropylene (HFP), vinylidene fluoride |
| | (VDF), and optionally a perfluoro(alkyl vinyl) |
| | ether (obtained from Dyneon LLC, Oakdale, MN) |
| HTE 1510 | Copolymers of TFE, HFP, and ethylene (ET) |
| | (obtained from Dyneon LLC, Oakdale, MN) |
| THV 500G | Copolymer of TFE, HFP, VDF and optionally a |
| | perfluoro(alkyl vinyl) ether (obtained from |
| | Dyneon LLC, Oakdale, MN) |
| HTE 1705 | Copolymer of TFE, HFP and ET (obtained from |
| | Dyneon LLC, Oakdale, MN) |
| THV 815G | Copolymer of TFE, HFP, VDF and optionally a |
| | perfluoro(alkyl vinyl) ether (obtained from |
| | Dyneon LLC, Oakdale, MN) |
| FEP 6322 | Copolymer of TFE and HFP (obtained from Dyneon |
| | LLC, Oakdale, MN) |
| ETFE 6235 | Copolymers of ET and TFE (obtained from Dyneon |
| | LLC, Oakdale, MN) |
| Polymer C | Copolymer of TFE, HFP, and 1.8 mol % perfluoro |
| | (propyl vinyl) ether monomers |
| Polymer C + Fproc | Copolymer of TFE, HFP, and perfluoro(propyl |
| | vinyl) ether monomers subjected to a |
| | fluorination process |
| Polymer B | 2 parts of perfluoro(propyl vinyl) ether to 100 |
| | parts of a copolymer of TFE, VDF and HFP |

Melt Point Data: Table 1A below summarizes melt point data for the fluoroplastics used in Examples 1-7.

TABLE 1A

| Fluoroplastic | Melt Point (° C.) |
|---|---|
| THV 220G | 120 |
| HTE 1510 | 160 |
| THV 500G | 165 |
| HTE 1705 | 210 |
| THV 815G | 225 |
| FEP 6322 | 255 |
| ETFE 6235 | 267 |
| Polymer C + Fproc | 290 |
| Polymer C | 290 |
| Polymer B | 225 |

### Example 1

A copolymer of TFE, HFP, VDF and optionally a perfluoro(alkyl vinyl)ether obtained under the trade designation “THV 500G” (Dyneon LLC, Oakdale, Minn.) was extruded at 245-250° C. onto a sample of a GMA modified polymer obtained under the trade designation “LOTADER” (Arkema, Puteaux, France) and high density polyethylene obtained under the trade designation “HDPE B53-35H 100” (BP-Solvay, Houston, Tex.). The results are summarized in Table 1, below.

TABLE 1

| | Fluoropolymer | | |
|---|---|---|---|
| | Extrusion | GMA-modified | Initial Bonding |
| Fluoropolymer | Temperature | polymer | (N/cm) |
| THV 500G | 245-250° C. | LOTADER AX8840 | 13.3 |
| THV 500G | 245-250° C. | LOTADER AX8900 | 16.1 |
| THV 500G | 245-250° C. | LOTADER AX8920 | 27.8 |

### Example 2

Example 2 was carried out as described for Example 1 except that a copolymer of TFE, HFP and ET (obtained under the trade designation “HTE 1705” (Dyneon LLC, Oakdale, Minn.) was used instead of a copolymer of TFE, HFP, VDF and optionally a perfluoro(alkyl vinyl)ether obtained under the trade designation “THV 500G”(Dyneon LLC, Oakdale, Minn.), and was extruded at a temperature of 255-265° C. (based on its higher melting point). Table 2, below, summarizes the bonding results.

TABLE 2

| | Fluoropolymer | | |
|---|---|---|---|
| | Extrusion | GMA-modified | Initial Bonding |
| Fluoropolymer | Temperature | polymer | (N/cm) |
| HTE 1705 | 255-265° C. | LOTADER AX8840 | 45.0 |
| HTE 1705 | 255-265° C. | LOTADER AX8900 | 42.5 |
| HTE 1705 | 255-265° C. | LOTADER AX8920 | 57.4 |

### Example 3

Example 3 was carried out as described in Example 1, except that a copolymer of TFE, HFP, VDF and optionally a perfluoro(alkyl vinyl)ether obtained under the trade designation “THV 815G” (Dyneon LLC, Oakdale, Minn.) was used instead of a copolymer of TFE, HFP, VDF and optionally a perfluoro(alkyl vinyl)ether obtained under the trade designation “THV 500G” (Dyneon LLC, Oakdale, Minn.), and was extruded at a temperature of 270-280° C. (based on its higher melting point). Table 3, below, summarizes the bonding results.

TABLE 3

| | Fluoropolymer | | |
|---|---|---|---|
| | Extrusion | GMA-modified | Initial Bonding |
| Fluoropolymer | Temperature | polymer | (N/cm) |
| THV 815G | 270-280° C. | LOTADER AX8840 | ^{a} |
| THV 815G | 270-280° C. | LOTADER AX8900 | ^{a} |
| THV 815G | 270-280° C. | LOTADER AX8920 | ^{a} |

^{a} Bond strength so high, unable to delaminate under experimental conditions.

### Example 4

Several laminates were prepared by pressing a partially fluorinated fluoropolymer layer with a second polymer selected from a GMA modified polymer obtained under the trade designation “LOTADER” (Arkema, Puteaux, France), ethylene vinylacetate, 12% vinyl acetate obtained under the trade designation “ATEVA 1240A” (AT Plastics, Edmonton, Canada), and ethylene methylmethacrylate, 18% methylmethacrylate obtained under the trade designation “ACRYFT 303 WK” (Sumitomo Chemical of America, New York, N.Y.). The second layer polymers were pressed at 160° C. for 30 seconds and at a pressure of 69 bar (1000 psi). Laminates were then created by pressing at least two layers (typically three layers) together, typically a fluoropolymer layer, a second layer, and a third layer of fluoropolymer or high density polyethylene (HDPE). Between each layer of the laminate was placed a piece of PFA film (a copolymer of tetrafluoroethylene and perfluorovinylether), which serves to start a separation between the layers. The press temperatures are given in Table 4, below. Initial bonding measurements were carried out as described above for Plaque Initial Bonding Measurements. The results are shown in Table 4, below:

TABLE 4

| | Fluoropolymer | | Press | Initial |
|---|---|---|---|---|
| | Thickness | | Temperature | Bonding |
| Fluoropolymer | (micrometers) | Second layer | (° C.) | (N/cm) |
| THV 220G | 375 | ATEVA | 216 | 0 |
| | | 1240A | | |
| THV 220G | 375 | ACRYFT | 216 | 0 |
| | | 303WK | | |
| Polymer B | 250 | LOTADER | 249 | 39.2 |
| | | AX8900 | | |
| Polymer B | 250 | LOTADER | 249 | 37.0 |
| | | AX8920 | | |
| Polymer B | 250 | ATEVA | 249 | 0 |
| | | 1240A | | |
| ETFE 6235 | 200 | LOTADER | 280 | 14.0 |
| | | AX8840 | | |
| ETFE 6235 | 200 | LOTADER | 280 | 53.6 |
| | | AX8900 | | |
| ETFE 6235 | 200 | LOTADER | 280 | 51.6 |
| | | AX8920 | | |

### Comparative Example 5

Comparative Example 5 was carried out as described for Example 4, except that instead of a partially fluorinated fluoropolymer, a perfluorinated fluoropolymer (FEP), a copolymer of hexafluoropropylene and tetrafluoroethylene, (obtained under the trade designation “FEP 6322” (Dyneon LLC, Oakdale, Minn.) was used. The results are shown in Table 5, below.

TABLE 5

| | Fluoropolymer | | Press | Initial |
|---|---|---|---|---|
| | Thickness | | Temperature | Bonding |
| Fluoropolymer | (micrometers) | Second layer | (° C.) | (N/cm) |
| FEP 6322 | 250 | LOTADER | 280 | 0 |
| | | AX8840 | | |
| FEP 6322 | 250 | LOTADER | 280 | 0 |
| | | AX8900 | | |
| FEP 6322 | 250 | LOTADER | 280 | 0 |
| | | AX8920 | | |

### Example 6

Multilayer articles were prepared by bonding a polyethylene terephthalate film (PET, containing 13% TiO₂) coated with ethylene vinyl acetate to glass through a second layer of ethylene vinyl acetate obtained under the trade designation “15420P/UF” (Specialized Technology Resources, Enfield, Conn.). A film of GMA-modified polymer was then laid on top of the PET film and upon the GMA-modified polymer was laid a fluoropolymer film. Between each layer adjacent to the GMA-modified polymer, a separation was started between layers as described in Comparative Example 5. The multilayer article was then laminated under vacuum at 180° C. for 8 minutes at 5 mbar pressure. The initial bonding tests, measured according to the Plaque Initial Bonding Measurement described above, are summarized in Table 6, below.

TABLE 6

| | | Bond strength between | Bond strength |
|---|---|---|---|
| | GMA- | fluoropolymer and | between PET film |
| | modified | GMA-modified | and GMA- |
| Fluoropolymer | polymer | polymer | modified polymer |
| THV 500G ^{a} | LOTADER | 10.5 | 3.8 |
| | AX8840 | | |
| THV 500G ^{a} | LOTADER | ^{b} | 12.9 |
| | AX8920 | | |

^{a} Added 2 wt % blend of THV 220G and TiO₂ obtained under the trade designation “AMERICHEM 17274-CD2” (Americhem, Cuyahoga Falls, Ohio)
^{b} Bond strength so high, the sample tabs broke under experimental conditions.

### Example 7

Example 7 was carried out as described for Comparative Example 5, except that instead of FEP, a perfluorinated polymer comprised of tetrafluoroethylene, hexafluoropropylene, and perfluoropropyl vinyl ether monomers (Polymer C), as described in U.S. Pat. No. 6,653,379, was used. In the first two entries in Table 7, the polymers were further subjected to a fluorination process (FProc), as described in U.S. Pat. No. 6,693,164, before the films were prepared. The results are shown in Table 7, below.

TABLE 7

| | Fluoropolymer | | Press | End Group | Initial |
|---|---|---|---|---|---|
| | Thickness | Second | Temperature | Count (per | Bonding |
| Fluoropolymer | (micrometers) | layer | (° C.) | 10⁶ C atoms) | (N/cm) |
| Polymer C + | 250 | LOTADER | 315 | 0 | 0.0 |
| Fproc | | AX8840 | | | |
| Polymer C + | 250 | LOTADER | 315 | 0 | 0.0 |
| Fproc | | AX8900 | | | |
| Polymer C | 250 | LOTADER | 315 | 93 | 14.7 |
| | | AX8840 | | | |
| Polymer C | 250 | LOTADER | 315 | 93 | 5.2 |
| | | AX8900 | | | |

1. A multilayer article comprising:
a) a first layer comprising a partially fluorinated fluoroplastic having a melting point measured by DSC of at least 200° C.;
b) a second layer comprising a copolymer comprising interpolymerized units derived from at least one monomer having a glycidyl functional group, wherein the second layer is substantially free of curatives; and
c) a substrate layer wherein the second layer is disposed between the first layer and the substrate layer and adhesively bonds the first layer to the substrate layer.

2. The multilayer article of claim 1 wherein the partially fluorinated fluoroplastic has a melting point of at least 220° C.

3. (canceled)

4. The multilayer article of claim 3 wherein the partially fluorinated fluoroplastic comprises from 50 to 60 mol % tetrafluoroethylene; from 5 to 15 mol % hexafluoropropylene; and from 25 to 35 mol % vinylidene fluoride.

5. The multilayer article of claim 3 wherein the partially fluorinated fluoroplastic comprises from 55 to 65 mol % tetrafluoroethylene; from 5 to 15 mol % hexafluoropropylene; and from 20 to 30 mol % vinylidene fluoride.

6. The multilayer article of claim 3 wherein the partially fluorinated fluoroplastic comprises from 60 to 70 mol % tetrafluoroethylene; from 5 to 15 mol % hexafluoropropylene; and from 20 to 30 mol % vinylidene fluoride.

7. The multilayer article of claim [[3]]1 wherein the partially fluorinated fluoroplastic comprises from 70 to 80 mol % tetrafluoroethylene; from 5 to 15 mol % hexafluoropropylene; from 15 to 25 mol % vinylidene fluoride; and from 0 to 5 mol % perfluoro(alkyl vinyl)ether.

8. The multilayer article of claim 3 wherein the partially fluorinated fluoroplastic comprises from 75 to 85 mol % tetrafluoroethylene; from 1 to 10 mol % hexafluoropropylene; and from 10 to 20 mol % vinylidene fluoride.

9. The multilayer article of claim 1 wherein the copolymer of the second layer comprises from 1 to 8 percent by weight of the monomer having a glycidyl functional group.

10. The multilayer article of claim 1 wherein the copolymer of the second layer comprises a copolymer of glycidyl methacrylate and an alpha-olefin.

11-13. (canceled)

14. The multilayer article of claim 13 wherein the number of unstable end groups in the perfluoroplastic is less than 30 per 10⁶ carbon atoms.

15-17. (canceled)

18. The multilayer article of claim 1 wherein an interface between the first and second layer is substantially free of adhesive-promoting materials.

19. A multilayer article comprising:
a) a first layer comprising a partially fluorinated fluoroplastic;
b) a second layer comprising a copolymer comprising interpolymerized units derived from at least one monomer having less than 2 weight percent of a glycidyl functional group, wherein the second layer is substantially free of curatives; and
c) a substrate layer wherein the second layer is disposed between the first layer and the substrate layer and adhesively bonds the first layer to the substrate layer.

20. The multilayer article of claim 17 wherein the partially fluorinated fluoroplastic comprises from 35 to 45 mol % tetrafluoroethylene; from 5 to 15 mol % hexafluoropropylene; and from 45 to 55 mol % vinylidene fluoride.

21. The multilayer article of claim 17 wherein the partially fluorinated fluoroplastic comprises from 40 to 50 mol % tetrafluoroethylene; from 10 to 20 mol % hexafluoropropylene; from 30 to 40 mol % vinylidene fluoride; and from 1 to 5 mol % perfluoro(alkyl vinyl)ether.

22. The multilayer article of claim 17 wherein the partially fluorinated fluoroplastic comprises from 50 to 60 mol % tetrafluoroethylene; from 10 to 20 mol % hexafluoropropylene; and from 30 to 40 weight percent vinylidene fluoride.

23. (canceled)

24. The multilayer article of claim 23 wherein the number of unstable end groups in the perfluoroplastic is less than 30 per 10⁶ carbon atoms.

25. A multilayer article comprising:
a) a first layer comprising a perfluoroplastic;
b) a second intermediate bonding layer comprising a copolymer comprising interpolymerized units derived from at least one monomer having a glycidyl functional group; and
c) a substrate layer wherein the second layer is disposed in between the first layer and the substrate and adhesively bonds the first layer to the substrate layer;
wherein the first layer includes a number of unstable end groups selected such that the first layer adhesively bonds to the second layer.

26. The multilayer article according to claim 25 wherein the number of unstable end groups in the perfluoroplastic is greater than 30 per 10⁶ carbon atoms.

27. The multilayer article according to claim 25 wherein the number of unstable end groups in the perfluoroplastic is greater than 60 per 10⁶ carbon atoms.

28. The multilayer article according to claim 25 wherein the number of unstable end groups is greater in the perfluoroplastic than 90 per 10⁶ carbon atoms.

29-31. (canceled)
